(19) United States
(12) Patent Application Publication
(10) Pub. No.: US 2002/0103766 A1
(43) Pub. Date: Aug. 1, 2002

(54) Controlled purchase systems

(76) Inventor: Alfred L. Chi, Westwood, MA (US)

Correspondence Address: CELIA H. LEBER, Fish & Richardson P.C., 225 Franklin Street, Boston, MA, 02110-2804, US

(21) Appl. No.: 09/772,748

(22) Filed: Jan. 30, 2001

(51) Int. Cl. G06F 17/60

(52) U.S. Cl. 705/74; 705/78; 705/44; 705/26; 705/64

(57) ABSTRACT

Virtual purchase information, which does not include any identifier of a real financial account, is provided, in an on-line connection to a merchant, to pay for an item. The merchant provides the item and the virtual purchase information to a delivery service. At the delivery service, the virtual purchase information is converted to a real delivery address, and the item is delivered to the delivery address.

### TECHNICAL FIELD

This invention relates to controlled purchase systems.

### RELATED APPLICATIONS

Related subject matter, including the VETO-Applied accounts and Virtual Express Transaction Orders (VETOs) discussed below, is disclosed in copending U.S. patent application Ser. No. 09/564,163, filed on May 3, 2000, U.S. patent application Ser. No. 09/549,440, filed on Apr. 14, 2000, and U.S. patent application Ser. No. 09/502,147, filed on Feb. 11, 2000. The disclosures of these applications are incorporated herein by reference.

### BACKGROUND

When a consumer buys a product through the Internet or by phone, for example, the consumer gives the merchant personal and financial account information that may include his name, address, phone number, email address, and credit card information. Some websites allow the consumer to save the information at the website so that it is not necessary to reenter the information for future purchases each time the customer wishes to make a purchase. While most websites provide a “secure” connection for entering this information, customers are sometimes concerned about the potential for fraudulent use of the personal information. Such personal and financial account information is often stored in merchants' database systems and may be stolen by computer hackers or sold to third parties by merchants.

### SUMMARY

The invention enables a customer to make a purchase and receive delivery of the purchased item without providing personal and financial account information to the merchant, reducing concerns regarding privacy and security, and facilitating easy purchasing.

In one aspect, the invention features a method in which (a) virtual purchase information, which does not include any identifier of a real financial account, is provided, in an on-line connection to a merchant, to pay for of an item, (b) the merchant provides the item and the virtual purchase information to a delivery service, (c) at the delivery service, the virtual purchase information is converted to a real delivery address, and (d) the item is delivered to the delivery address.

Implementations of the invention may include one or more of the following features. The virtual purchase information includes a virtual account identifier, e.g., a VETO-applied account number. The virtual purchase information includes a virtual account transaction order. The virtual account transaction order includes a VETO order. The method also includes physically associating a label that contains the virtual purchase information with the item. The delivery service includes FEDEX, UPS or the United States Postal Service. The method also includes storing the real delivery address and the related virtual purchase information in a database under the control of the delivery service. The virtual purchase information is associated with a real financial account.

In another aspect, the invention features a method in which (a) virtual delivery information, which does not include any identifier of a real delivery address, is provided, in an on-line connection to a merchant, with respect to a purchase of an item, (b) the merchant provides the item and the virtual delivery information to a delivery service, (c) at the delivery service, the virtual delivery information is converted to a delivery address, and (d) the item is delivered to the delivery address.

Implementations of the invention may include one or more of the following features. The method also includes physically associating a label that contains the virtual delivery information with the item. The delivery service includes FEDEX, UPS or the United States Postal Service. The method also includes storing the real delivery address and the related virtual delivery information in a database under the control of the delivery service.

In a further aspect, the invention features a method that includes (a) providing real delivery information to a delivery service, (b) associating with the delivery information a code that does not itself reveal the delivery information, (c) making the code known to the delivery service, and (d) in connection with a purchase of an item that is to be delivered according to the delivery information, providing the code to a merchant for forwarding to the delivery service.

Implementations of the invention may include one or more of the following features. The real delivery information includes personal information about a purchaser. The personal information includes a name and an address. The code is provided to the merchant electronically through a communication network. Alternatively, the code is provided to the merchant telephonically. The method also includes the forwarding of the code to the delivery service. The method also includes delivering the item.

In yet another aspect, the invention features a method that includes (a) at a delivery service, storing personal delivery information associated with a consumer and storing a code corresponding to the personal delivery information, the code not itself revealing the personal delivery information, (b) receiving from a merchant a package for delivery to the consumer, and a code representing delivery information for the package, (c) using the stored information and code to translate the code to the personal delivery information, and (d) delivering the package in accordance with the personal delivery information.

Implementations of the invention may include one or more of the following features. The personal delivery information includes a name and an address and may include other personal information. Multiple packages bearing the code are received at different times.

The invention also features an apparatus including a package to be delivered to a customer, the package containing an item sold by a merchant to the customer, and a code representing delivery instructions for the package, the code not itself revealing the delivery instructions, the package being free of any direct indication of the delivery instructions so that a person observing the package is unable to determine the delivery instructions without knowledge of the association between the code and the delivery instructions.

In addition, the invention features a method including (a) delivering a package to a package delivery service, the package containing an item sold by a merchant to the customer, and (b) providing to the package delivery service a code representing delivery instructions for the package, the code not itself revealing the delivery instructions, the package being free of any direct indication of the delivery instructions so that a person observing the package is unable to determine the delivery instructions without knowledge of the association between the code and the delivery instructions.

In another aspect, the invention features a method including (a) establishing a virtual account with a virtual account issuer, the virtual account being associated with a financial account, (b) associating a package delivery code with the virtual account, the package delivery code representing, but not itself revealing, delivery instructions for packages directed to a holder of the virtual account, and (c) providing the package delivery code to a package delivery service for use in delivering packages of items purchased from merchants using the virtual account.

Other features and advantages of the invention will be apparent from the description and drawings, and from the claims.

### DESCRIPTION OF DRAWINGS

FIG. 1 is a schematic block diagram illustrating a virtual account system.

FIG. 2 is an example of a form used by a holder of a virtual account.

FIG. 3 is a schematic block diagram illustrating a system for purchasing and delivering items according to one embodiment of the invention.

FIG. 3A is a schematic block diagram illustrating a system for purchasing and delivering items according to an alternate embodiment of the invention.

### DETAILED DESCRIPTION

One implementation of the invention is described below. The terms “VETO”, “BIGKEY” and “SMALLKEY”, which are trademarks of Veto Corporation, are used for convenience in the following text and accompanying figures by way of example only. The use of these terms or of the following examples based on them does not limit the scope of the claims in any respect.

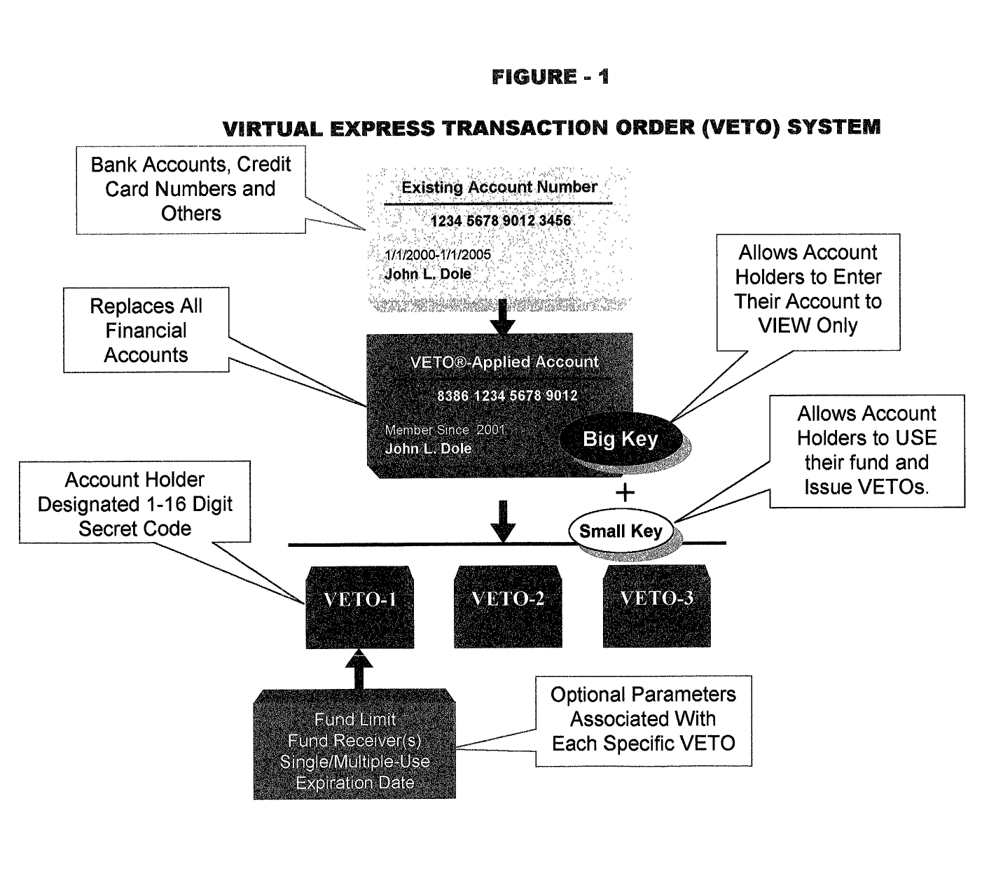

Referring to FIG. 1, prior to making a purchase, the user first obtains a VETO-Applied Account by registering with an intermediary. This may be accomplished, for example, as described in the copending U.S. patent applications referred to above and incorporated herein by reference, e.g. U.S. Ser. No. 09/564,163 (“the Ser. No. 09/564,163 application”). The VETO-Applied Account is associated with one or more of the user's existing financial accounts (e.g., credit cards, bank account, debit account). After the VETO account issuer validates the information submitted, the user receives a magnetic card with the user's VETO-Applied Account Number. This account number is used to replace the account numbers of the user's existing financial account(s) and will stay the same permanently. The user's VETO-Applied Account Number is used in all transaction verification processes and is registered with parcel delivery companies, as will be discussed below. The VETO-Applied Account is not valid for payment until the accountholder has transferred funds from existing financial accounts and obtained a pre-approved VETO, as will now be discussed.

Once the user has established the VETO-Applied account, the user can obtain a Virtual Express Transaction Order (VETO) from the intermediary. The VETO is a one-time or multiple-time accountholder-validated and account-issuer pre-approved code, which typically has 1 to 16 alphanumeric digits. The VETO is associated with a specific amount of money, which is transferred from the associated active existing financial account(s) of the user to the user's (accountholder's) VETO-Applied Account. The VETO-Applied Account functions as a replacement for any or all real financial accounts of the accountholder. Optional parameters can be selected to be associated with a specific VETO, such as the fund receiver, the fund limit, one-time use or multiple uses, and expiration date of the fund. Validation of a financial transaction requires a VETO-Applied Account and a valid VETO that are provided by the accountholder; the VETO-Applied Account is only valid with a pre-approved VETO.

Access to the VETO-Applied Account System requires two separate passwords. A first password (the “BIGKEY” password) guards the entrance to the whole system and controls access to the user's general account information, such as transaction history, account balance, check issuance and the VETO submission tool. Withdrawing funds from the user's existing accounts and obtaining a VETO requires an additional password (the “SMALLKEY” password). With either one of the passwords alone, one cannot withdraw funds or obtain a valid VETO.

As discussed in the Ser. No. 09/564,163 application, accountholders can access their VETO-Applied Account management systems either through the Internet (a web-based system) or by telephone to complete VETO-Applied financial transactions. A web-based VETO system allows accountholders to integrate all their financial accounts into one—the VETO-Applied Account. Funds can be freely transferred among all the accounts that customers enter into the VETO-Applied Account. This integrated VETO-Applied Account provides a sufficient and flexible management tool for families and businesses to oversee their financial activities. For instance, parents can issue a VETO-specific VETO-Applied Account to children who need funds for college expenses. Once the fund for the specific VETO is depleted, parents can simply issue another VETO with another amount of money. The same approach can apply to corporate business account management. The accounting department can issue as many VETO-specific VETO-Applied Accounts as needed for short term fund uses such as travel expense, bill paying, fund transfers or even payroll purposes. The invention described herein is another application of the VETO system, in which an integrated e-purchase system is used to enable VETO account holders to make e-purchases, i.e., purchases made online or by telephone, without revealing personal and financial account information to merchants.

The web-based VETO system is designed for accountholders who have some experience using a computer and accessing the Internet. To obtain a VETO-Applied Account using a web-based VETO system, a user is first required to complete a sign-up page to register with the VETO account issuer (the intermediary). General information such as name, address, phone number, social security number, and e-mail address are required. It is important that the accountholder provide the correct information in order to validate the existing financial account(s) that will be applied to the VETO system.

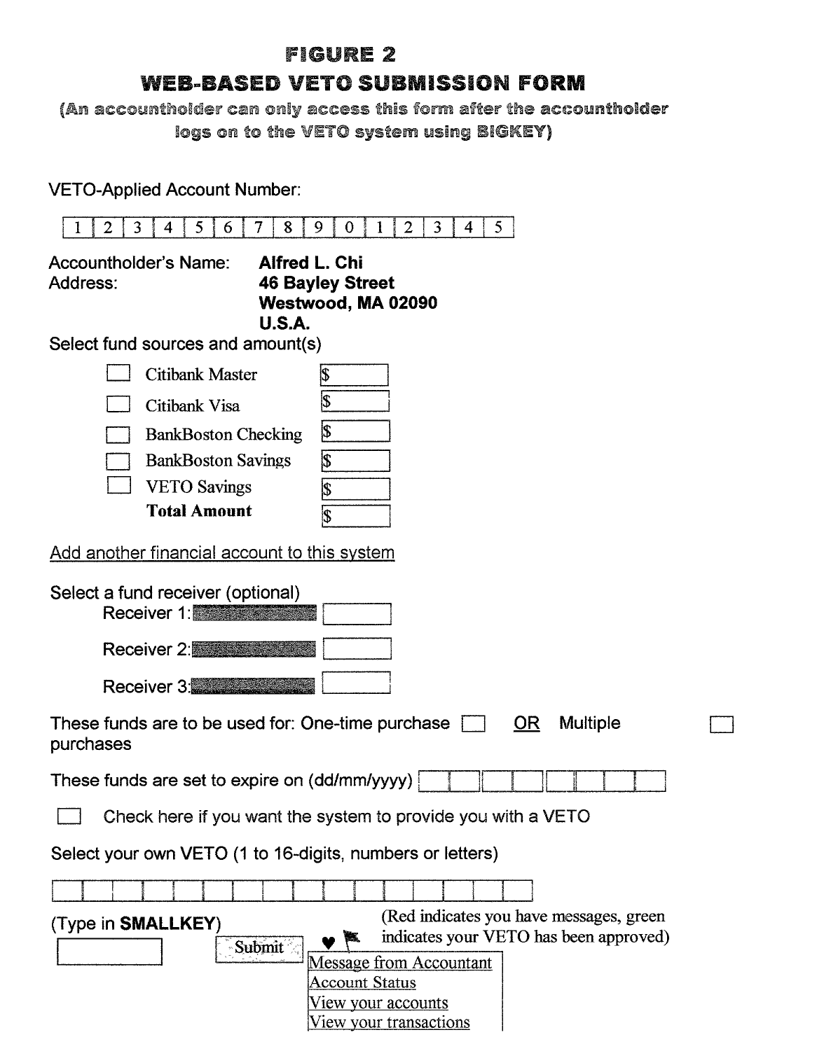

To obtain a VETO using a web-based system, the user completes a VETO submission form, e.g., as shown in FIG. 2. Using this form, the accountholder indicates the amount, source, and/or purpose of the funds. The accountholder identifies whether the funds will be for a one-time purchase or multiple purchases within a designated time period. Finally, the accountholder selects a VETO (from 1 digits up to 16-digits, letters or numbers) for the funds or allows the system to provide a random VETO. The system will then validate the availability of the funds in the existing source account(s) that the accountholder indicated. Upon the completion of the verification procedure, the accountholder will be notified of the status (approved or declined) of the submitted VETO through the intermediary's account center and/or by personal e-mail.

A recipient can collect a VETO fund using the same web-based system. To do so, the recipient enters the intermediary's website, navigates to the “Collect Veto Funds” page, and enters the sender's VETO-Applied Account Number and the valid VETO. Payment can be received in the form of checks, or directly deposited into one of the financial accounts of the recipient financial accounts, including those accounts already in the VETO system. Payment can also be used to obtain another VETO.

The automated phone-based VETO system, discussed in the Ser. No. 09/564,163 application, is designed for customers who want to obtain and subsequently access a VETO-Applied Account and issue new VETOs, but do not have the ability to or do not wish to access the Internet. To obtain a VETO-Applied Account, a user mails in a registration form with information on the financial accounts that the user wants to apply to the VETO-Applied Account. The VETO Account Issuer (the intermediary) will then send back the system logon information and instructions for using this system, along with the VETO-Applied Account information. VETOs can then be obtained using the automated phone-based VETO system, as described in the Ser. No. 09/564,163 application.

Once a requested VETO is approved, the user can use it anywhere for any purpose—shopping online, shopping onsite, issuing a check or personal fund transfer. The use of the VETO system to make an e-purchase online, over the Internet, is discussed in detail below.

The VETO system discussed above is suitable for application to many current financial account management systems, to prevent various forms of transaction fraud and wrongful charges. These include credit card systems, including corporate credit cards, bank ATM card systems, debit card systems, and check/money order transaction systems.

The VETO system provides a highly secure, flexible, and reliable way of managing various personal accounts online. Users do not need to use, or release to vendors, any of their financial account numbers and personal information. As a result, fraud is deterred and losses to creditors and individual cardholders are generally reduced. Also, the credibility of payments is increased for retail industries, especially e-retailers. The system can be used to generate one-time-valid VETO for on-line purchases without worrying about stolen account numbers, fraud, hidden costs, and wrongful charges. Additionally, the risk of loss from the financial accounts is reduced to the amount of the transactions authorized by any single VETO, if in fact that the pre-approved VETO were stolen.

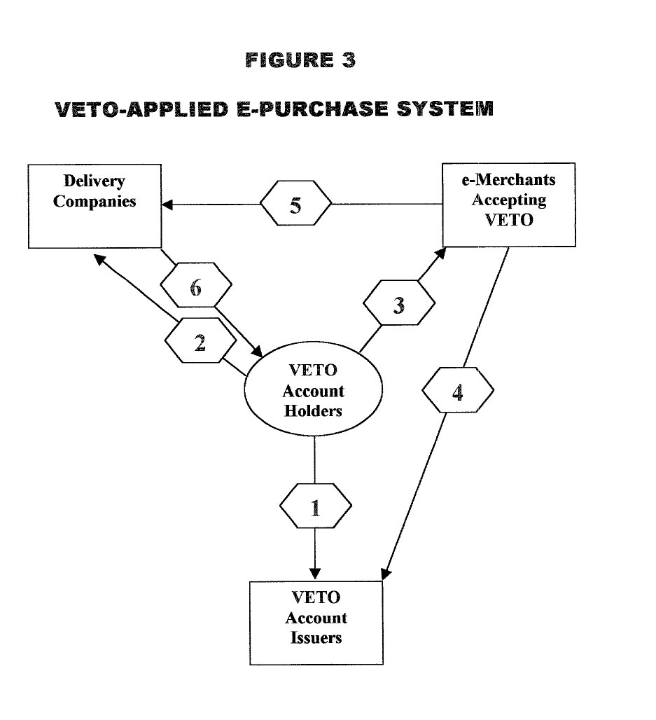

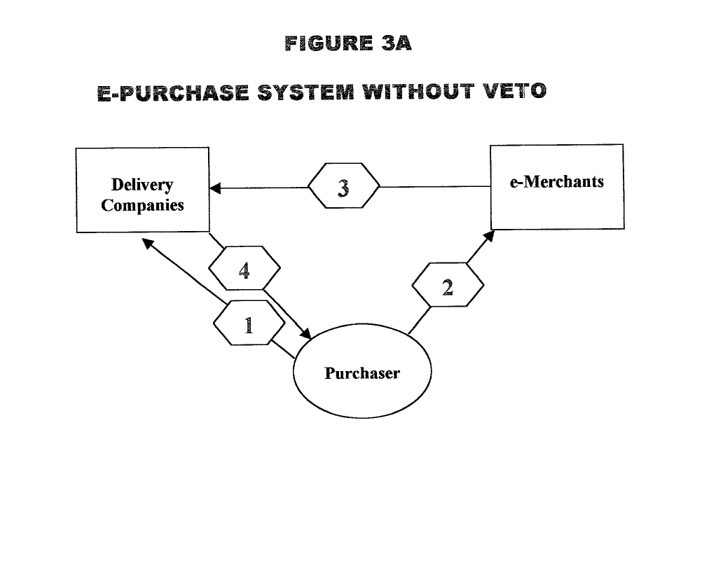

By using the VETO-Applied E-purchase System, shown in FIG. 3, VETO accountholders can make purchases online, over the telephone, or in person without revealing their personal and financial information to the merchant from whom the purchase is being made. To utilize the E-purchase System, the user first obtains a VETO-Applied Account then issues a VETO, as discussed above (FIG. 3, step 1). Next, the user registers with a selected delivery company (FIG. 3, step 2). To register, the VETO account-holder submits his personal information such as name, address and phone number, and his VETO-Applied Account Number, to one or more delivery companies. All of these companies work with the intermediary to provide delivery of the intermediary's goods. While it is necessary for the account-holder to provide personal information to the delivery company, the delivery company is generally a highly reputable service provider, e.g., Federal Express, who is unlikely to use the information in a fraudulent manner. Moreover, such companies are generally bound more strongly by federal law than are online merchants never to disclose the name or address of the party to whom a package is delivered. Moreover, the account-holder needs to give the information only once, rather than many times to different merchants.

Next, when the user wishes to make a purchase online or over the Internet, instead of giving the merchant his name, mailing address, telephone number, credit card account numbers and other information, the account-holder needs only to give the merchant his VETO-Applied Account Number and the pre-approved VETO, and select the delivery company with which the account-holder has registered (FIG. 3, step 3). To collect payment for the purchase, the merchant provides the account-holder's VETO-Applied Account Number and VETO to the VETO account issuer (the intermediary), who then makes payment from the user's financial accounts (FIG. 3, step 4).

The merchant then prints a shipping label including the account-holder's VETO-Applied Account Number and name of the selected delivery company and forwards the package to the selected delivery company (FIG. 3, step 5). To ship the purchase to the user, the delivery company scans in the VETO-Applied Account Number on the package to identify the account-holder's delivery address, stored in the delivery company's records, and completes the delivery. The VETO-Applied Account Number may be used by the delivery company as the tracking number for the package to be delivered.

Other embodiments are within the scope of the claims. For example, in an alternative implementation, shown schematically in FIG. 3A, an e-purchase is made without first obtaining a VETO-Applied Account and VETO. Instead, referring to FIG. 3A, a purchaser first registers with a selected delivery company (step 1), as discussed above, and is given a CODE that is assigned by the delivery company, e.g., a 16-digit number card. The purchaser then submits the CODE to the merchant, when making a purchase using a credit card or other payment method (step 2). The merchant prints a shipping label that includes the purchaser's CODE, and forwards the package to the selected delivery company (step 3). The delivery company scans the CODE on the package to identify the purchaser's delivery address, and completes delivery (step 4).

What is claimed is:

1. A method in which
virtual purchase information, which does not include any identifier of a real financial account, is provided, in an on-line connection to a merchant, to pay for of an item,
the merchant provides the item and the virtual purchase information to a delivery service,
at the delivery service, the virtual purchase information is converted to a real delivery address, and
the item is delivered to the delivery address.

2. The method of claim 1 in which the virtual purchase information includes a virtual account identifier.

3. The method of claim 2 in which the virtual purchase information includes a VETO-applied account number.

4. The method of claim 1 in which the virtual purchase information includes a virtual account transaction order.

5. The method of claim 4 in which the virtual account transaction order comprises a VETO order.

6. The method of claim 1 also including physically associating a label that contains the virtual purchase information with the item.

7. The method of claim 1 in which the delivery service includes FEDEX or UPS or the United States Postal Service.

8. The method of claim 1 also including storing the real delivery address and the related virtual purchase information in a database under the control of the delivery service.

9. The method of claim 1 in which the virtual purchase information is associated with a real financial account.

10. A method in which
virtual delivery information, which does not include any identifier of a real delivery address, is provided, in an on-line connection to a merchant, with respect to a purchase of an item,
the merchant provides the item and the virtual delivery information to a delivery service,
at the delivery service, the virtual delivery information is converted to a delivery address, and
the item is delivered to the delivery address.

11. The method of claim 10 also including physically associating a label that contains the virtual delivery information with the item.

12. The method of claim 10 in which the delivery service includes FEDEX or UPS or the United States Postal Service.

13. The method of claim 10 also including storing the real delivery address and the related virtual delivery information in a database under the control of the delivery service.

14. A method comprising
providing real delivery information to a delivery service,
associating with the delivery information a code that does not itself reveal the delivery information,
making the code known to the delivery service, and
in connection with a purchase of an item that is to be delivered according to the delivery information, providing the code to a merchant for forwarding to the delivery service.

15. The method of claim 14 in which the real delivery information includes personal information about a purchaser.

16. The method of claim 14 in which the personal information includes a name and an address.

17. The method of claim 14 in which the code is provided to the merchant electronically through a communication network.

18. The method of claim 14 in which the code is provided to the merchant telephonically.

19. The method of claim 14 also including the forwarding of the code to the delivery service.

20. The method of claim 14 also including delivering the item.

21. A method comprising
at a delivery service, storing personal delivery information associated with a consumer and storing a code corresponding to the personal delivery information, the code not itself revealing the personal delivery information,
receiving from a merchant a package for delivery to the consumer, and a code representing delivery information for the package,
using the stored information and code to translate the code to the personal delivery information, and
delivering the package in accordance with the personal delivery information.

22. The method of claim 21 in which the personal delivery information includes a name and an address and may include other personal information.

23. The method of claim 11 in which multiple packages bearing the code are received at different times.

24. Apparatus comprising
a package to be delivered to a customer, the package containing an item sold by a merchant to the customer, and
a code representing delivery instructions for the package, the code not itself revealing the delivery instructions,
the package being free of any direct indication of the delivery instructions so that a person observing the package is unable to determine the delivery instructions without knowledge of the association between the code and the delivery instructions.

25. A method comprising
delivering a package to a package delivery service, the package containing an item sold by a merchant to the customer,
providing to the package delivery service a code representing delivery instructions for the package, the code not itself revealing the delivery instructions,
the package being free of any direct indication of the delivery instructions so that a person observing the package is unable to determine the delivery instructions without knowledge of the association between the code and the delivery instructions.

26. A method comprising
establishing a virtual account with a virtual account issuer, the virtual account being associated with a financial account,
associating a package delivery code with the virtual account, the package delivery code representing, but not itself revealing, delivery instructions for packages directed to a holder of the virtual account, and
providing the package delivery code to a package delivery service for use in delivering packages of items purchased from merchants using the virtual account.
